(19) United States
(12) Patent Application Publication
(10) Pub. No.: US 2012/0275524 A1
(43) Pub. Date: Nov. 1, 2012

(54) SYSTEMS AND METHODS FOR PROCESSING SHADOWS IN COMPRESSED VIDEO IMAGES

(75) Inventors: Cheng-Chang LIEN, Zhubei City (TW); En-Jung Fam, Hsinchu City (TW); Yue-Min Jiang, New Taipei City (TW); Hung-I Pai, New Taipei City (TW); Kung-Ming Lan, Jiaoxi Township (TW)

(73) Assignee: Industrial Technology Research Institute, Hsinchu (TW)

(21) Appl. No.: 13/096,691

(22) Filed: Apr. 28, 2011

(51) Int. Cl. H04N 7/26

(52) U.S. Cl. 375/240.24; 375/240.01; 375/E07.076

(57) ABSTRACT

Methods and systems are disclosed for processing compressed video images. A processor detects a candidate object region from the compressed video images. The candidate object region includes a moving object and a shadow associated with the moving object. For each data block in the candidate object region, the processor calculates an amount of encoding data used to encode temporal changes in the respective data block. The processor then identifies the shadow in the candidate object region composed of data blocks each having the amount of encoding data below a threshold value.

### FIELD OF THE INVENTION

This disclosure relates in general to systems and methods for processing shadows of moving objects represented in compressed video images.

### BACKGROUND

Multimedia technologies, including those for video- and image-related applications, are widely used in various fields, such as security surveillance, medical diagnosis, education, entertainment, and business presentations. For example, the use of high resolution videos are becoming more and more popular in the security surveillance applications so that important security information is captured in real time with improved resolutions, such as a million pixels or more per image. In security surveillance systems, videos are usually recorded by video cameras, and the recorded raw video data are compressed before the video files are transmitted to or stored in a storage device or a security monitoring center. The video files can then be analyzed by processing devices.

Moving objects are of significant interest in surveillance applications. For example, surveillance videos taken at the entrance of a private building may be analyzed to identify whether an unauthorized person attempts to enter the building. For example, the surveillance system may identify the moving trajectory of a moving object. If the trajectory indicates that a person has reached a certain position, an alarm may be triggered or a security guard may be notified. Therefore, detecting the moving objects and identifying their moving trajectories may provide useful information for assuring the security of the monitored site.

However, many lighting conditions cause video cameras to record the shadows of moving objects in video images. To identify accurate moving trajectories, the shadows associated with moving objects need to be removed from the recorded video images. Otherwise, false alarm may be triggered, or miscalculation may result. Traditional image processing methods require that the compressed video data transmitted from the video camera be uncompressed before shadow detection and removal. Uncompressing high resolution video data, however, is usually time-consuming and may sometimes require expensive computation resources.

Therefore, it may be desirable to have systems and/or methods that process compressed video images and/or detect a shadow associated with a moving object in the compressed video images.

### SUMMARY

Consistent with embodiments of the present invention, there is provided a computer-implemented method for processing compressed video images. The method detects a candidate object region from the compressed video images. The candidate object region includes a moving object and a shadow associated with the moving object. For each data block in the candidate object region, the method calculates an amount of encoding data used to encode temporal changes in the respective data block. The method then identifies the shadow in the candidate object region composed of data blocks each having the amount of encoding data below a threshold value.

Consistent with embodiments of present invention, there is also provided another computer-implemented method for processing compressed video images. The method detects an object image region representing a moving object from the compressed video images. The compressed video images include a shadow associated with the moving object. The method then determines a hypothetical moving object based on the detected object image region. The method further creates an environmental model in which the compressed video images are obtained, and determines a hypothetical shadow for the hypothetical moving object based on the environmental model.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are incorporated in and constitute a part of this specification, illustrate disclosed embodiments described below.

In the drawings,

FIG. 1 shows an exemplary surveillance system, consistent with certain disclosed embodiments;

FIG. 2 shows a flow chart of an exemplary process for detecting a shadow of a moving object in the compressed image domain, consistent with certain disclosed embodiments;

FIG. 3 illustrates an exemplary video image having moving objects and their associated shadows, consistent with certain disclosed embodiments;

FIG. 4 shows a flow chart of an exemplary process for detecting a shadow in an H.264 compressed video image, consistent with certain disclosed embodiments;

FIG. 5 illustrates exemplary encodings of a moving object and its associated shadow, consistent with certain disclosed embodiments;

FIG. 6 shows a flow chart of an exemplary process for detecting a shadow based on an environmental simulation, consistent with certain disclosed embodiments;

FIG. 7 shows exemplary hypothetical moving objects in an environmental model, consistent with certain disclosed embodiments; and

FIG. 8 shows a flow chart of an exemplary process for shadow searching, consistent with the disclosed embodiments.

### DESCRIPTION OF THE EMBODIMENTS

Reference will now be made in detail to the exemplary embodiments of the disclosure, examples of which are illustrated in the accompanying drawings. Wherever possible, the same reference numbers will be used throughout the drawings to refer to the same or like parts.

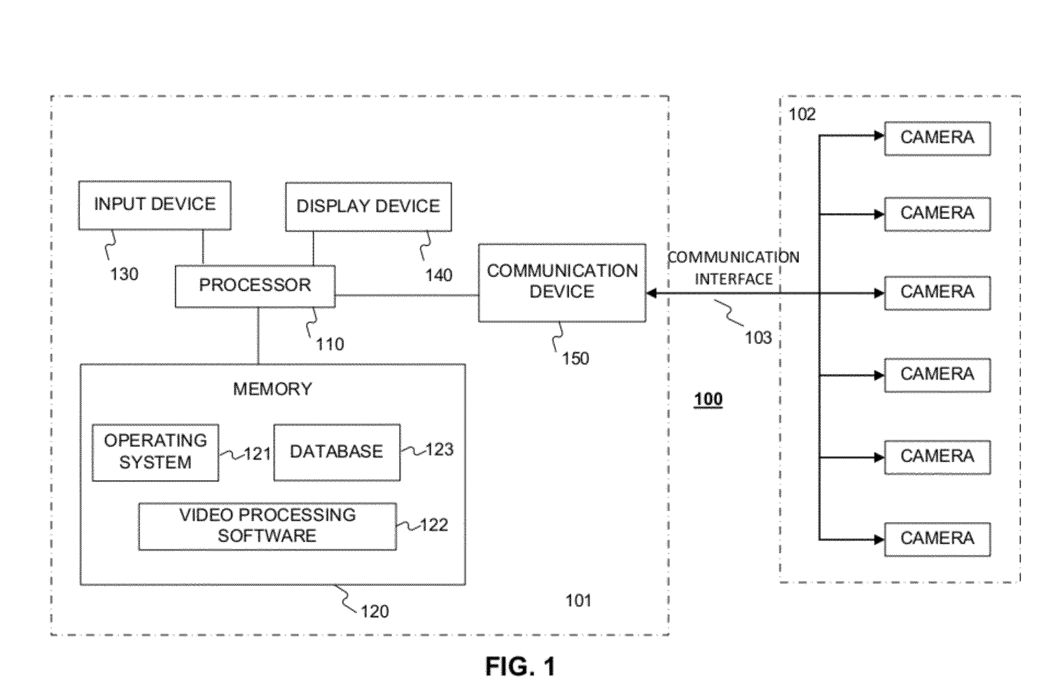

FIG. 1 shows an exemplary surveillance system 100. Consistent with embodiments of the present disclosure, surveillance system 100 may be installed at various places for monitoring the activities occurring at these places. For example, surveillance system 100 may be installed at a bank facility, a government building, a museum, a supermarket, a hospital, or a site with restricted access.

Consistent with some embodiments, surveillance system 100 may include a video processing and monitoring system 101, a plurality of surveillance cameras 102, and a communication interface 103. For example, surveillance cameras 102 may be distributed throughout the monitored site, and video processing and monitoring system 101 may be located on the site or remote from the site. Video processing and monitoring system 101 and surveillance cameras 102 may communicate via communication interface 103. Communication interface 103 may be a wired or wireless communication network. In some embodiments, communication interface 103 may have a bandwidth sufficient to transmit video images from surveillance cameras 102 to video processing and monitoring system 101 in real time.

Surveillance cameras 102 may be video cameras, such as analog closed-circuit television (CCTV) cameras or internet protocol (IP) cameras, configured to capture video images of one or more surveillance regions. For example, a video camera may be installed above the entrance of a bank branch or next to an ATM machine. In some embodiments, surveillance cameras 102 may be connected to a recording device, such as a central network video recorder (not shown), configured to record the video images. In some other embodiments, surveillance cameras 102 may have built-in recording functionalities, and can thus record directly to digital storage media, such as flash drives, hard disk drives or network attached storage.

The video data acquired by surveillance cameras 102 may be compressed before it is transmitted to video processing and monitoring system 101. Consistent with the present disclosure, video compression refers to reducing the quantity of data used to represent digital video images. Therefore, given a pre-determined band-width on communication interface 103, compressed video data can be transmitted faster than the original/uncompressed video data. Accordingly, the video images can be displayed on video processing and monitoring system 101 in real-time.

Video compression may be implemented as a combination of spatial image compression and temporal motion compensation. Various video compression methods may be used to compress the video data, such as discrete cosine transform (DCT), discrete wavelet transform (DWT), fractural compression, matching pursuit, etc. In particular, several video compression standards have been developed based on DCT, including H.120, H.261, MPEG-1, H.262/MPEG-2, H.263, MPEG-4, and H.264/MPEG-4 AVC. H.264 is currently one of the most commonly used formats for the recording, compression, and distribution of high definition video. Thus, the present disclosure discusses embodiments of the invention associated with video data compressed under the H.264 standard. However, it is contemplated that the invention can be applied to video data compressed with any other compression standards or methods.

As shown in FIG. 1, video processing and monitoring system 101 may include a processor 110, a memory module 120, a user input device 130, a display device 140, and a communication device 150. Processor 110 can be a central processing unit (“CPU”) or a graphic processing unit (“GPU”). Depending on the type of hardware being used, processor 110 can include one or more printed circuit boards, and/or a microprocessor chip. Processor 110 can execute sequences of computer program instructions to perform various methods that will be explained in greater detail below. Consistent with some embodiments, processor 110 may be a H.264 decoder configured to decompress the video image data compressed under H.264 standard.

Memory module 120 can include, among other things, a random access memory (“RAM”) and a read-only memory (“ROM”). The computer program instructions can be accessed and read from the ROM, or any other suitable memory location, and loaded into the RAM for execution by processor 110. For example, memory module 120 may store one or more software applications. Software applications stored in memory module 120 may comprise operating system 121 for common computer systems as well as for software-controlled devices. Further, memory module may store an entire software application or only a part of a software application that is executable by processor 110. In some embodiments, memory module may store video processing software 122 that may be executed by processor 110. For example, video processing software 122 may be executed to remove shadows from the compressed video images.

It is also contemplated that video l processing software 122 or portions of it may be stored on a removable computer readable medium, such as a hard drive, computer disk, CD-ROM, DVD ROM, CD+RW or DVD±RW, USB flash drive, memory stick, or any other suitable medium, and may run on any suitable component of video processing and monitoring system 101. For example, portions of applications to perform video processing may reside on a removable computer readable medium and be read and acted upon by processor 110 using routines that have been copied to memory 120.

In some embodiments, memory module 120 may also store master data, user data, application data and/or program code. For example, memory module 120 may store a database 123 having therein various compressed video data transmitted from surveillance cameras 102.

In some embodiments, input device 130 and display device 140 may be coupled to processor 110 through appropriate interfacing circuitry. In some embodiments, input device 130 may be a hardware keyboard, a keypad, or a touch screen, through which an authorized user, such as a security guard, may input information to video processing and monitoring system 101. Display device 140 may include one or more display screens that display video images or any related information to the user.

Communication device 150 may provide communication connections such that video processing and monitoring system 101 may exchange data with external devices, such as video cameras 102. Consistent with some embodiments, communication device 150 may include a network interface (not shown) configured to receive compressed video data from communication interface 103.

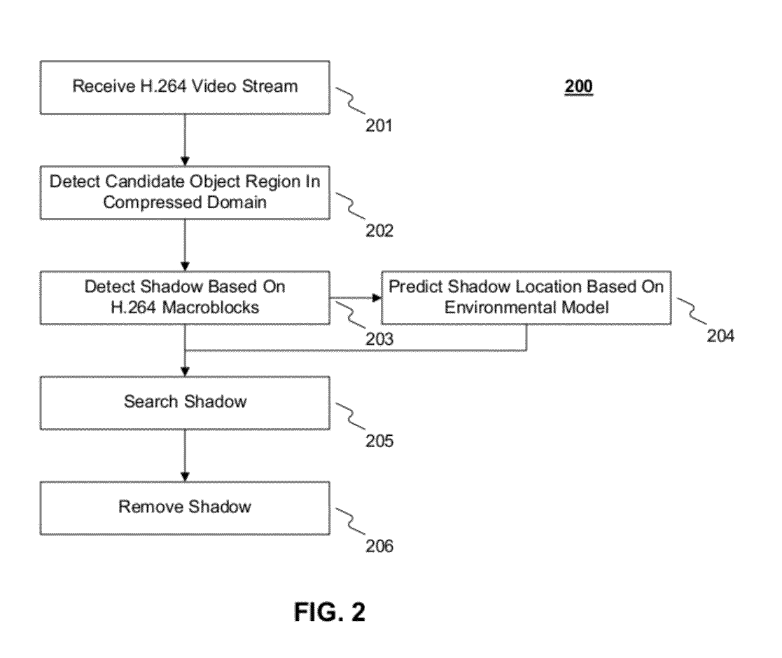

One or more components of surveillance system 100 may be used to implement a process related to video processing. For example, FIG. 2 shows a flow chart of an exemplary process 200 for detecting a shadow of a moving object in the compressed image domain. Process 200 may begin when compressed video stream is received (step 201). For example, video data may be recorded and compressed by surveillance cameras 102 using H.264 standards, and transmitted to video processing and monitoring system 101 via communication interface 103. The video data represents a series of video images recording information of the monitored area at different time points.

In some embodiments, the video stream may include video data coded in the form of macroblocks. Macroblocks are usually composed of two or more blocks of pixels. The size of a block may depend on the codec and is usually a multiple of 4. For example, in modern codecs such as H.263 and H.264, the overarching macroblock size may be fixed at 16×16 pixels, but can be broken down into smaller blocks or partitions which are either 4, 8, 12 or 16 pixels by 4, 8, 12 or 16 pixels.

Color and luminance information may be encoded in the macroblocks. For example, a macroblock may contain 4 Y (luminance) block, 1 Cb (blue color difference) block, 1 Cr (red color difference) block. In an example of an 8×8 macroblock, the luminance may be encoded at an 8×8 pixel size and the difference-red and difference-blue information each at a size of 2×2. In some embodiments, the macroblock may further include header information describing the encoding. For example, it may include an ADDR unit indicating the address of block in the video image, a TYPE unit identifying type of the macroblock (e.g., intra-frame, inter frame, bi-directional inter frame), a QUANT unit indicating the quantization value to vary quantization, a VECTOR unit storing a motion vector, a CBP unit storing a bit mask indicating how well the blocks in the macroblock match.

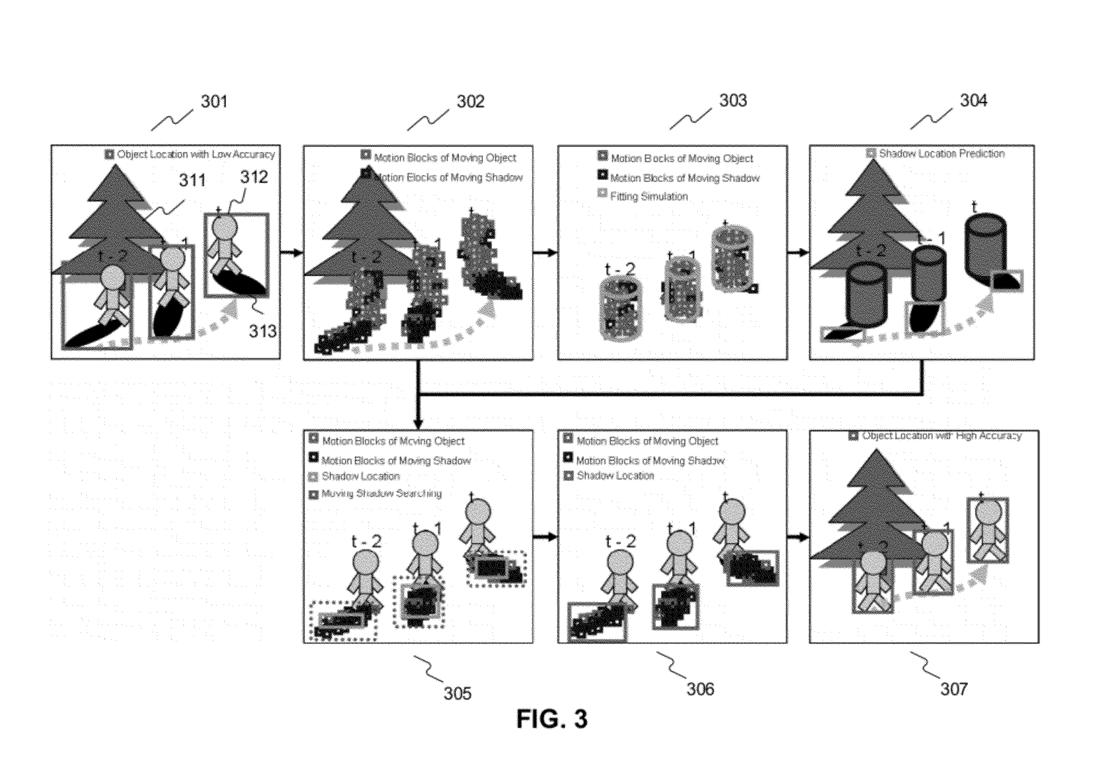

The video images may usually show several objects, including static objects and moving objects. Due to the existence of lighting sources, the video images may also show shadows of these objects. In particular, the shapes, sizes, and orientations of the shadows associated with moving objects may vary throughout time. For example, FIG. 3 illustrates an exemplary video image having moving objects and shadows. Image 301 shows a static object 311, e.g., a tree. Image 301 further shows a moving object 312, e.g., a person, as well as a shadow 313 of moving object 312. Moving object 312 and shadow 313 may show up at different locations in the image at different time points. Image 301 shows their locations at time points t-2, t-1, and t.

In step 202 of process 200, candidate object regions corresponding to one or more moving objects and their respective shadows may be detected in the compressed video images. In some embodiments, candidate object regions may be detected based on the compressed video data without decompressing it into the raw data domain. Image 302 of FIG. 3 shows the detected candidate object regions at time points t-2, t-1, and t, respectively. In some embodiments, a candidate image region may include both the moving object and its shadow.

In some embodiments, various image segmentation methods may be used to detect the candidate object regions. For example, processor 110 may aggregate temporally adjacent video images, and calculate the motion vector for each “block” in the aggregated images. Because motion vector is indicative of the temporal changes within a block, a block with larger motion vector may be identified as part of the candidate object region. In addition, or in alternative, processor 110 may also calculate a difference between two temporally adjacent video images based on encoded image features such as luminance, color, and displacement vector, etc. Based on the calculated difference, processor 110 may further identify if a block belongs to the candidate object region or the background. Processor 110 may further “connect” the identified blocks into a continuous region. For example, processor 110 may determine the candidate image region as a continuous region that covers the identified blocks. In some embodiments, processor 110 may label the blocks in the candidate image region.

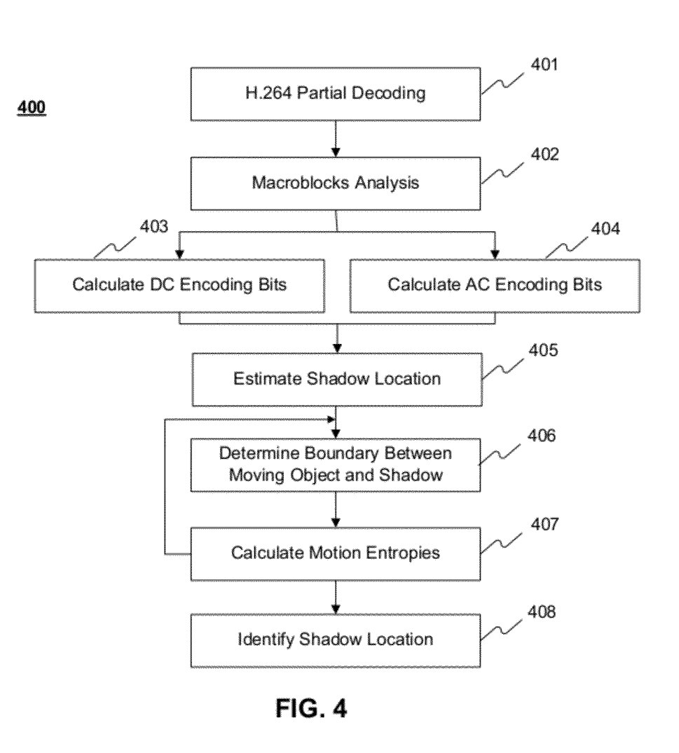

In step 203 of process 200, the shadow may be detected in the candidate object region. In some embodiments, the detection may be made based on H.264 macroblocks. For example, FIG. 4 shows a flow chart of an exemplary process 400 for detecting a shadow in an H.264 compressed video image. In step 401, the H.264 compressed video data may be partially decoded to obtain information for the macroblocks. In step 402, the macroblocks in the candidate image regions may be analyzed.

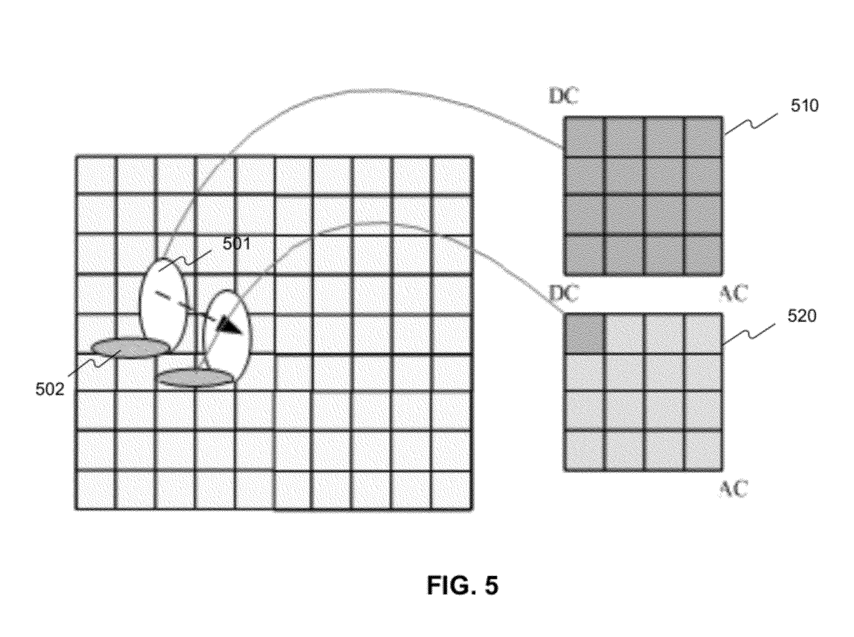

For example, for each macroblock in the candidate object regions, processor 110 may calculate the DC encoding bits (step 403) and AC encoding bits (step 404) used to encode the corresponding video data. FIG. 5 illustrates exemplary encodings of a moving object 501 and a shadow 502. For DCT based compression methods, DC encoding bits usually encode homogeneous changes in luminance, while AC encoding bits usually encode changes in image patterns or colors. Since movement of moving object 501 may cause more inhomogeneous changes in patterns and colors, it may require a larger amount of encoding bits than shadow 502. As shown in FIG. 5, information of shadow 502 is mostly encoded in the DC encoding bits (see spectrum 520), while information of moving object 501 is usually encoded in both DC encoding bits and AC encoding bits (see spectrum 510). Therefore, in step 405, processor 110 may estimate the location of moving object 501 or shadow 502 within the candidate image region, based on the spectral distribution of encoding data of each macroblock.

In some embodiments, in steps 403 and 404, processor 110 may calculate the amount of encoding data (e.g., amount of information carried by the DC and AC encoding bits) used to encode temporal change information of a macroblock. Accordingly, in step 405, processor 110 may identify an estimated shadow region, from the candidate object region, that is composed of those macroblocks that have smaller amounts of encoding data. For example, processor 110 may compare the amount of encoding data of each macroblock with a predetermined threshold, and if the threshold is exceeded, the macroblock is labeled as part of moving object 501. Otherwise, the macroblock is labeled as part of shadow 502.

In some other embodiments, in steps 403 and 404, processor 110 may calculate the values of the encoding data for each macroblock. For example, processor 110 may calculate the DC and AC encoding bits. Since the AC encoding bits of moving object 501 tend to have higher values than the AC encoding bits of shadow 502, in step 405, processor 110 may identify an image region composed of those macroblocks that have larger-valued AC encoding bits, as the estimated shadow location.

Based on the estimation of shadow location in step 405, processor 110 may determine a boundary between moving object 501 and shadow 502 within the candidate image region (step 406). For example, the candidate object region may be divided into two parts by the boundary: a shadow image region and an object image region.

Processor 110 may further refine the boundary based on motion entropies of the two image regions. Each macroblock in the compressed video data may be associated with a motion vector that is a two-dimensional vector used for inter prediction that provides an offset from the coordinates in a video image to the coordinates in a reference image. Motion vectors associated with macroblocks in a moving object may share a similar or same movement direction, while motion vectors associated with macroblocks in a moving show may show various movement directions. Therefore, the motion entropy of the motion vectors associated with macroblocks of the shadow may usually be higher than those associated with the moving object. Accordingly, the boundary between moving object 501 and shadow 502 may be accurately set when the difference between the motion entropy for the shadow image region and the motion entropy for the object image region is maximized.

In some embodiments, the boundary may be refined using an iterative method. For example, in step 407, processor 110 may calculate a motion entropy for each of the shadow image region and the object image region separated by the boundary determined in step 406. Processor 110 may further determine the difference between the motion entropy for the shadow image region and the motion entropy for the object image region. Processor 110 may then go back to step 406 to slightly adjust the boundary, and execute step 407 again to determine another difference in motion entropies. Steps 406 and 407 may be repeated until the difference in motion entropies is maximized.

Based on the encoding bits calculated in steps 403 and 404, the motion entropies calculated in step 407, as well as the refined boundary determined in step 406, processor 110 may identify the location of the shadow 502 using various image segmentation and data fusion methods known in the art, such as Markov Random Field (MRF) classification method (step 408). Process 400 may then terminate after step 408.

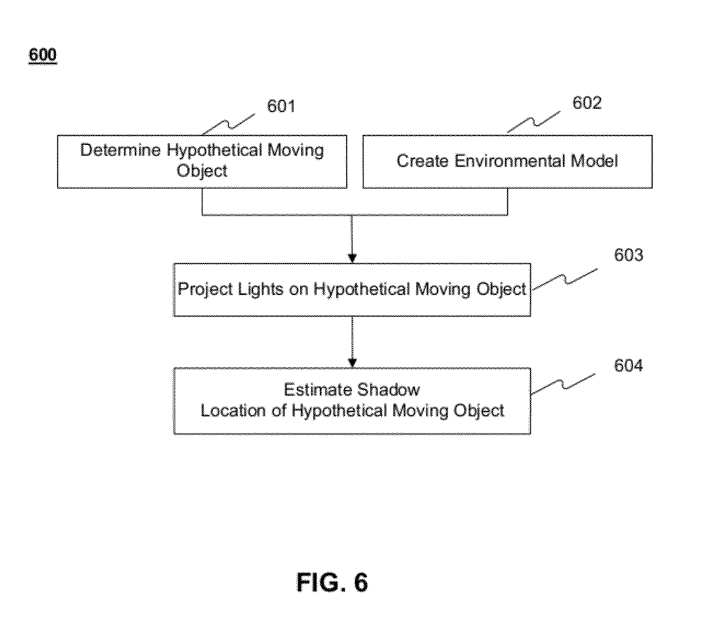

Returning to FIG. 2, after detection of the object image region based on macroblocks (step 203), in step 204 of process 200, the shadow location may be further predicated based on an environmental model. In some embodiments, the environmental configurations under which the video images are obtained may be simulated. For example, FIG. 6 shows a flow chart of an exemplary process 600 for detecting a shadow based on an environmental simulation.

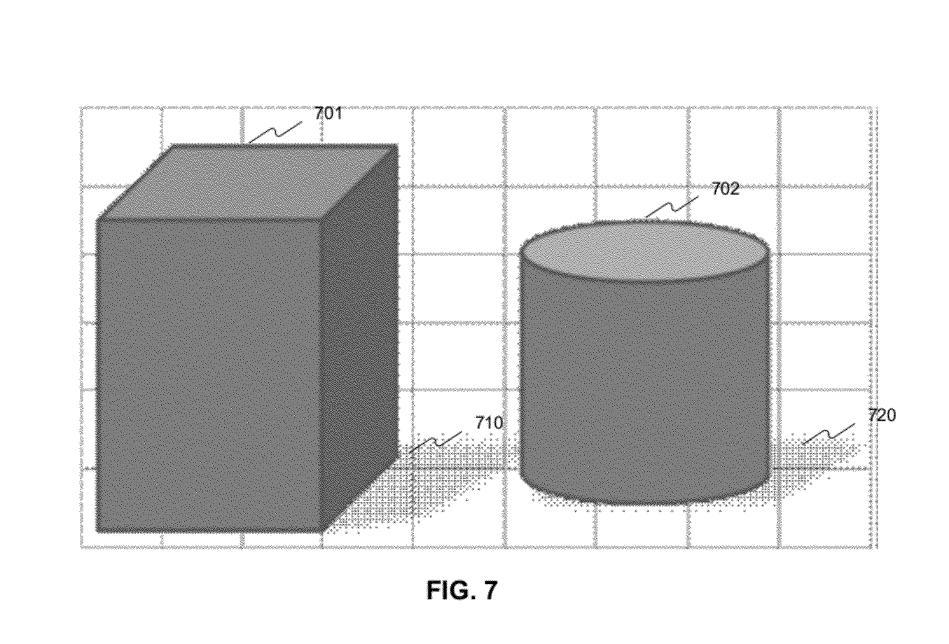

In step 601, a hypothetical moving object may be determined based on the object image region detected in step 203. For example, image 303 of FIG. 3 shows the hypothetical moving object overlaid with the detected object image region. In some embodiments, the hypothetical moving object may be in the form of a three-dimensional geometric model, such as a cylinder, a cube, a pyramid, etc. For example, FIG. 7 shows exemplary hypothetical moving objects 701 and 702. Hypothetical moving object 701 is modeled as a cube, and hypothetical moving object 702 is modeled as a cylinder.

In step 602, an environmental model may be created. In some embodiments, processor 110 may receive input of location information of lighting sources in the real monitored environment. Processor 110 may then create the environmental model that includes the lighting sources and the hypothetical moving objects. In step 603, processor 110 may simulate light projections onto the hypothetical moving objects from the locations of the lighting sources. Accordingly, in step 604, processor 110 may estimate the shadow locations of the hypothetical moving objects, such as hypothetical shadows 710 and 720, as shown in FIG. 7. As the moving object move in the monitored area, the size and shape of the shadow of the moving object may vary among different time points. For example, image 304 of FIG. 3 shows the hypothetical shadows of a cylindrical hypothetical moving object at different time points. Process 600 may terminate after step 604.

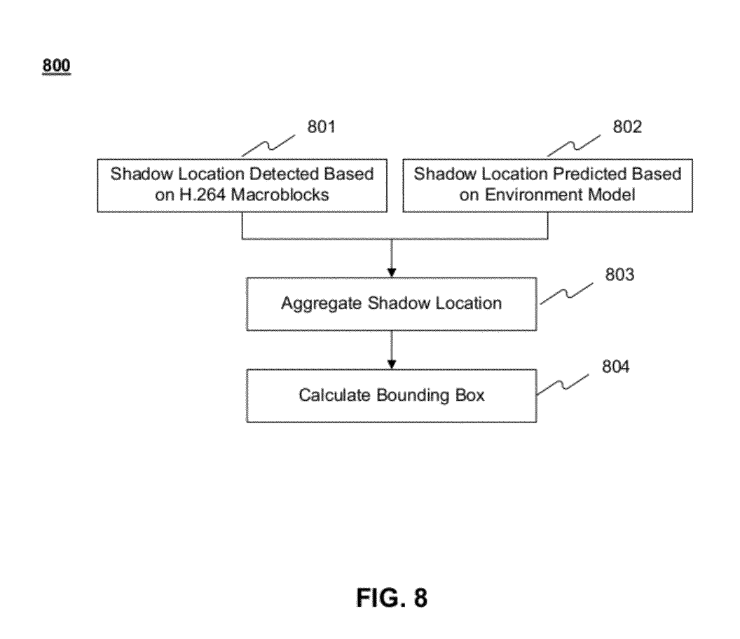

Returning to FIG. 2, after detection of shadow locations based on macroblocks (step 203) and the predication of shadow locations based on the environmental model (step 204), a search for the shadows from the compressed video images may be performed in step 205. For example, FIG. 8 shows a flow chart of an exemplary process 800 for shadow searching. In steps 801 and 802, the shadow locations detected based on H.264 macroblocks and shadow locations predicated based on the environmental model may be received by processor 110. These shadow locations may be aggregated together (step 803). For example, image 305 of FIG. 3 shows aggregated shadow locations of a moving object at different time points t-2, t-1, and t.

In step 804, processor 110 may calculate bounding boxes for the shadow locations. In some embodiments, a bounding box may be a rectangular box that covers the outset of an aggregated shadow location. For example, image 306 of FIG. 3 shows bounding boxes for the shadow locations at different time points. Although rectangular bounding boxes are illustrated, it is contemplated that bounding boxes may also be of any other suitable shapes, such as circular, elliptical, triangular, etc. Process 800 may terminate after step 804.

Returning to FIG. 2, in step 206, the shadows may be removed. In some embodiments, processor 110 may replace the video data of macroblocks within the bounding boxes with background video data. For example, processor 110 may use video data of neighboring macroblocks just outside the bounding boxes. Image 306 of FIG. 3 shows a video image with just the moving object, after the shadows are removed. In some embodiments, as part of step 206, processor 110 may further calculate a moving trajectory of the moving object. Process 200 may terminate after step 206.

It will be apparent to those skilled in the art that various modifications and variations can be made in the disclosed embodiments without departing from the scope or spirit of those disclosed embodiments. Other embodiments of the invention will be apparent to those skilled in the art from consideration of the specification. It is intended that the specification and examples be considered as exemplary only, with a true scope and spirit of the disclosed embodiments being indicated by the following claims.

What is claimed is:

1. A computer-implemented method for processing compressed video images, comprising:
detecting by a processor a candidate object region from the compressed video images, wherein the candidate object region includes a moving object and a shadow associated with the moving object;
for each data block in the candidate object region, calculating by the processor an amount of encoding data used to encode temporal changes in the respective data block; and
identifying by the processor the shadow in the candidate object region composed of data blocks each having the amount of encoding data below a threshold value.

2. The method of claim 1, wherein the compressed video images are compressed with an H.264 compression method.

3. The method of claim 1, wherein detecting the candidate object region comprises:
identifying a plurality of image regions from the compressed video images, wherein the image regions have predetermined encoded features; and
determining a continuous region that covers the plurality of image regions.

4. The method of claim 1, wherein the amount of encoding data is the amount of information carried by DC encoding bits and AC encoding bits of the respective data block.

5. The method of claim 4, further comprising calculating, for each data block, values of the DC encoding bits and the AC encoding bits.

6. The method of claim 5, wherein identifying the shadow includes identifying the data blocks having values of the AC encoding bits larger than a predetermined threshold.

7. The method of claim 1, wherein identifying the shadow includes determining a boundary between data blocks representing the moving object and data blocks representing the shadow.

8. The method of claim 7, wherein determining the boundary includes:
calculating a first entropy value for the motion vectors of the data blocks representing the moving object;
calculating a second entropy value for the motion vectors of the data blocks representing the shadow; and
determining a difference between the first entropy value and the second entropy value.

9. The method of claim 8, wherein identifying the shadow includes identifying the data blocks representing the shadow such that the difference is maximized.

10. The method of claim 1, further comprising removing the shadow from the video images by replacing data blocks in the shadow with background video data.

11. A computer-implemented method for processing compressed video images, comprising:
detecting by a processor an object image region representing a moving object from the compressed video images, wherein the compressed video images include a shadow associated with the moving object;
determining by the processor a hypothetical moving object based on the detected object image region;
creating by the processor an environmental model in which the compressed video images are obtained; and
determining by the processor a hypothetical shadow for the hypothetical moving object based on the environmental model.

12. The method of claim 11, further comprising:
receiving location information of lighting sources under which the compressed video images are obtained; and
projecting lights from the lighting sources on the hypothetical moving object.

13. The method of claim 11, further comprising:
searching for a shadow image region from the compressed video images that best matches the hypothetical shadow.

14. The method of claim 13, further comprising:
creating a bounding box based on the shadow image region; and
removing the shadow by replacing data blocks in the bounding box with background video data.

15. A system for processing compressed video images, comprising:
a storage device configured to store the compressed video images, wherein the compressed video images include a moving object and a shadow associated with the moving object; and
a processor coupled with the storage device and configured to:
detect a candidate object region from the compressed video images, wherein the candidate object region includes the moving object and a shadow associated with the moving object;
for each data block in the candidate object region, calculate an amount of encoding data used to encode temporal changes in the respective data block; and
identify the shadow in the candidate object region composed of data blocks each having the amount of encoding data below a threshold value.

16. The system of claim 15, wherein the processor is an H.264 decoder.

17. A non-transitory computer-readable medium with an executable program stored thereon, wherein the program instructs a processor to perform the following for processing compressed video images:
detecting a candidate object region from the compressed video images, wherein the candidate object region includes a moving object and a shadow associated with the moving object;
for each data block in the candidate object region, calculating an amount of encoding data used to encode temporal changes in the respective data block; and
identifying the shadow in the candidate object region composed of data blocks each having the amount of encoding data below a threshold value.

18. The non-transitory computer-readable medium of claim 17, wherein the amount of encoding data is the amount of information carried by DC encoding bits and AC encoding bits of the respective data block.

19. A system for processing compressed video images, comprising:
a storage device configured to store the compressed video images, wherein the compressed video images include a moving object and a shadow associated with the moving object; and
a processor coupled with the storage device and configured to:
detect an object image region representing the moving object from the compressed video images;
determine a hypothetical moving object based on the detected object image region;
create an environmental model in which the compressed video images are obtained; and
determine a hypothetical shadow for the hypothetical moving object based on the environmental model.

20. A non-transitory computer-readable medium with an executable program stored thereon, wherein the program instructs a processor to perform the following for processing compressed video images:
detecting an object image region representing a moving object from the compressed video images, wherein the compressed video images include a shadow associated with the moving object;
determining a hypothetical moving object based on the detected object image region;
creating an environmental model in which the compressed video images are obtained; and
determining a hypothetical shadow for the hypothetical moving object based on the environmental model.
